(19) United States
(12) Patent Application Publication
(10) Pub. No.: US 2017/0173804 A1
(43) Pub. Date: Jun. 22, 2017

(54) OPPOSED DUAL FOIL SHAVING HEADS AND TRIMMER

(71) Applicant: Troy Patrick Worth, Surrey (CA)

(72) Inventor: Troy Patrick Worth, Surrey (CA)

(21) Appl. No.: 14/972,692

(22) Filed: Dec. 17, 2015

(51) Int. Cl. B26B 19/38; B26B 19/04

(52) U.S. Cl. CPC B26B 19/384; B26B 19/04

(57) ABSTRACT

An electric shaving apparatus comprising a shaving head, the shaving head comprising: a) a round or an oval cylinder shaped housing having opposed housing holder portions; b) two opposed foil shaving portions; c) a dome shaped end cap at a first end of the housing; d) a shaving motor engagement portion at a second end of the housing; d) at least two push rods; e) at least two blade assemblies, wherein each blade assembly is independently positioned for lateral movement against the foil portions; and f) a double-armed drive portion mounted for pivotal movement about a central axis, wherein each push rod is independently pivotally attached at a first end to opposed sides of the double-armed drive portion.

### FIELD OF THE INVENTION

The present disclosure is in the field of an electric shaving apparatus and shaving heads.

### BACKGROUND OF THE DISCLOSURE

During a shaving operation, the foil is brought into intimate contact with the skin. As the shaving system is moved about an area to be shaved, hair and stubble pass through the apertures in the foil and are trimmed by the movable cutter, which repeatedly crosses the apertures in the foil. As such, the closeness, comfort and quality of the resulting shave are affected, at least in part, by the design of the foil.

This affect is exacerbated when the user shaves near or around the genital areas. Moreover, shavers on the market today are not designed to trim hair around the genitals in an efficient manner. Therefore, there is a need for improved trimmers and shaving device, in particular improvements in shaving head design for shaving the genital and buttocks areas.

### SUMMARY OF THE INVENTION

An electric shaving apparatus comprising a shaving head, the shaving head comprising: a) a round or an oval cylinder shaped housing having opposed housing holder portions; b) two opposed foil shaving portions; c) a dome shaped end cap at a first end of the housing; d) a shaving motor engagement portion at a second end of the housing; d) at least two push rods; e) at least two blade assemblies, wherein each blade assembly is independently positioned for lateral movement against the foil portions; and f) a double-armed drive portion mounted for pivotal movement about a central axis, wherein each push rod is independently pivotally attached at a first end to opposed sides of the double-armed drive portion.

An electric shaving apparatus comprising a shaving head, the shaving head comprising: a) a triangular shaped housing having angularly opposed housing holder portions; b) two opposed foil shaving portions; c) a shaving motor engagement portion at a second end of the housing; d) at least two push rods; e) at least two blade assemblies, wherein each blade assembly is independently positioned for lateral movement against the foil portions; and f) a double-armed drive portion mounted for pivotal movement about a central axis, wherein each push rod is independently pivotally attached at a first end to opposed sides of the double-armed drive portion.

An electric shaving apparatus comprising a hair trimming head, the hair trimming head comprising: a) a round or an oval cylinder shaped housing having a housing holder portion capable of holding a blade assembly, wherein the blade assembly is attached parallel to a latitude of the housing, wherein the blade assembly comprises: a stationary blade, and a reciprocating blade; b) a shaving motor engagement portion at a second end of the housing; c) at least one push rod; and d) a double-armed drive portion mounted for pivotal movement about a central axis, wherein the double-armed drive portion comprises a fixed free pin at a first side, and the at least one push rod is pivotally attached to an opposing side of the double-armed drive portion.

### BRIEF DESCRIPTION OF THE DRAWINGS

FIG. 1 is a cross section view of an illustration of a round or an oval cylinder shaped shaving head 100 having two opposed foil shaving portions 138 and 140.

FIG. 2 is a cross section view of an illustration of a triangular shaped shaving head 200 having two opposed foil shaving portions 138 and 140.

FIG. 3 is a cross section view of an illustration of a round or an oval cylinder shaped hair trimming head 300 having a single sided blade assembly comprising a stationary blade 304 and a reciprocating blade 328.

FIG. 4 is a blade side view of an illustration of a round or an oval cylinder shaped hair trimming head 400 having a single sided blade assembly comprising a stationary blade 304 and a reciprocating blade 328.

FIG. 5A is an exploded view of an illustration of a round or an oval cylinder shaped shaving head 500 having a foil shaving portion 502, blade assembly 504 and a round or an oval cylinder shaped housing with a housing holder portion 506.

FIG. 5B is a side view of an illustration of an electric shaving apparatus 600 comprising a shaving motor 602 having a rotatable cam 604.

### DETAILED DESCRIPTION OF THE EMBODIMENTS

The following is a detailed description of certain specific embodiments of the electric shaving apparatus and shaving heads disclosed herein. In this description reference is made to the drawings.

### DEFINITIONS

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### INTRODUCTION

In one aspect, disclosed herein is an electric shaving apparatus comprising a shaving head, the shaving head comprising: a) a round or an oval cylinder shaped housing having opposed housing holder portions; b) two opposed foil shaving portions; c) a dome shaped end cap at a first end of the housing; d) a shaving motor engagement portion at a second end of the housing; d) at least two push rods; e) at least two blade assemblies, wherein each blade assembly is independently positioned for lateral movement against the foil portions; and f) a double-armed drive portion mounted for pivotal movement about a central axis, wherein each push rod is independently pivotally attached at a first end to opposed sides of the double-armed drive portion.

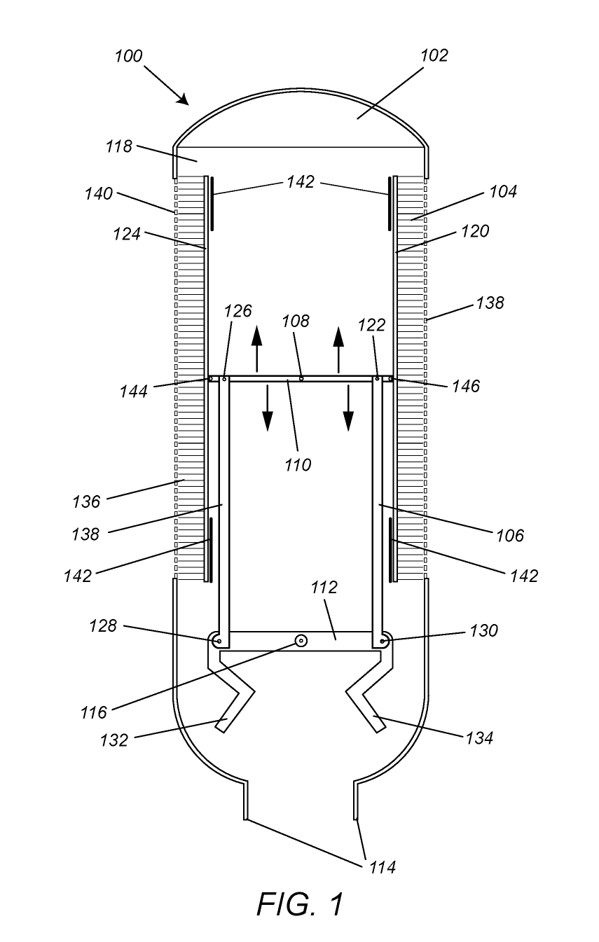

FIG. 1 cross section view of an illustration of a round or an oval cylinder shaped shaving head 100 having two opposed foil shaving portions 138 and 140. The oval cylinder shaped shaving head 100 includes a housing 118, whereby the two opposed foil shaving portions 138 and 140 each have a uniform thickness and a curvature. In some embodiments, the foil has a uniform thickness and a curvature, wherein the foil has a perforated region comprising a surface with a plurality of openings, and wherein each opening is separated from adjacent openings by a uniform distance. The reciprocating blades 104 and 136 are each attached to plastic or metal blade holders 120 and 124, respectively. In some embodiments, each blade assembly is attached to a blade holder and adjoined via a horizontal portion. FIG. 1 depicts the blade holders 120 and 124 are pivotally attached to the horizontal portion 110 comprising fixed free pins 144 and 146, which enables the horizontal portion 110 to rotate about its central axis via fixed free pin 108, between reciprocating blades 104 and 136.

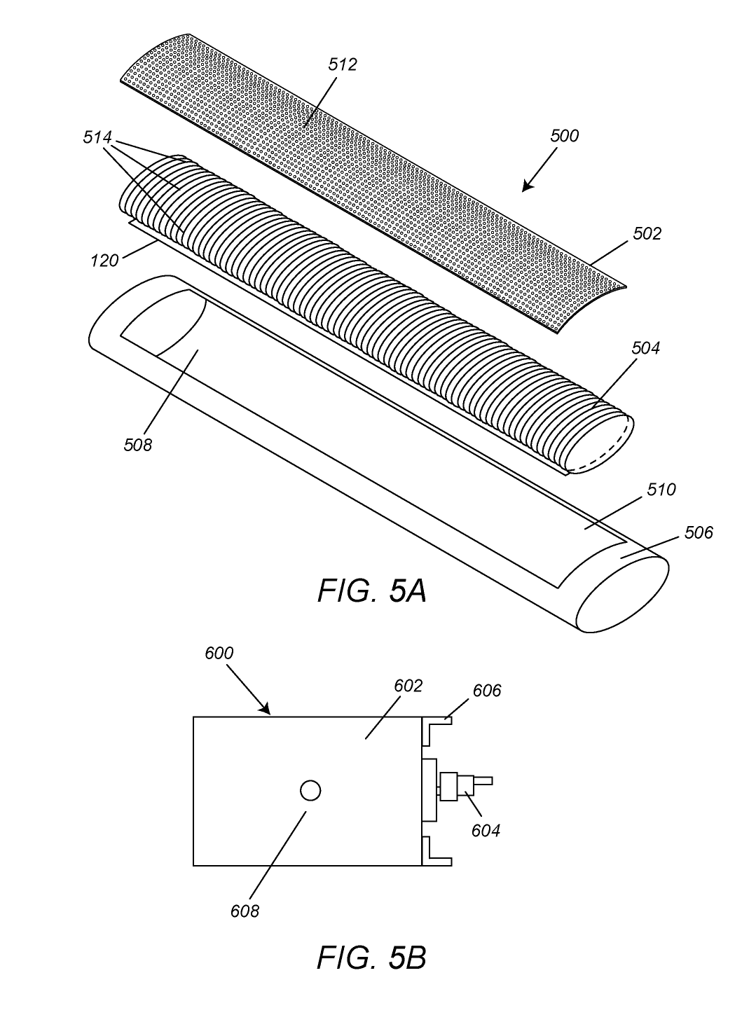

Referring to the drawings, FIGS. 1, 5A and 5B illustrate an illustration of a round or an oval cylinder shaped shaving head 100 having two opposed foil shaving portions 138 and 140 and an electric shaving apparatus 600 comprising a shaving motor 602 having a rotatable cam 604. The reciprocating blades 104 and 136 are oscillated laterally back and forth against the underside of the opposed foil shaving portions 138 and 140. In some embodiments, the shaving head comprises two push rods. Push rods 106 and 138 are pivotally attached to a left and right of the horizontal portion 110 as illustrated in FIG. 1 via free pins 122 and 126. In some embodiments, the round or an oval cylinder shaped shaving head further comprises a horizontal portion mounted for pivotal movement about a central axis and adjoining each blade assembly. In some embodiments, the round or an oval cylinder shaped shaving head further comprises a horizontal portion, wherein two push rods are pivotally adjoined at a second end to a left side of the horizontal portion and a right side of the horizontal portion. In some embodiments, the round or an oval cylinder shaped shaving head further comprises a horizontal portion mounted for pivotal movement about a central axis, wherein a first terminal end of the horizontal portion is mounted to about the center of a first blade assembly and a second terminal end of the horizontal portion is mounted to about the center of a second blade assembly.

Moreover, the round or an oval cylinder shaped shaving head 100 comprises a double-armed drive portion 112, wherein the double-armed drive portion movement is provided by rotation of the rotating cam 604. The rotating cam 604 rotates and engages with the left arm 132 and right arm 134 double-armed drive portion 112 which is attached to the housing via a free fix pin 116, thereby providing oscillating up and down movement of push rods 106 and 138, which are pivotally attached to the left arm 132 and right arm 134 via free pins 128 and 130. The oscillating up and down movement of push rods 106 and 138 provides rotational movement to the horizontal portion 110, which moves reciprocating blades 104 and 136 in an opposite direction relative to each other. The shaving motor engagement portion 114 is capable of attaching to the shaving motor housing 606 and allowing for engagement with the rotating cam 604. In some embodiments, the round or an oval cylinder shaped shaving head further comprises that the shaving motor engagement portion is capable of engagement a rotating cam, wherein the double-armed drive portion movement is provided by rotation of the cam. In some embodiments, the round or an oval cylinder shaped shaving head further comprises that the shaving motor engagement portion is capable of engagement a rotating cam, wherein the cam rotation results in the pivotal movement of the double-armed drive portion, wherein the pivotal movement of the double-armed drive portion results in up and down movement of each push rod, wherein the up and down movement of each push rod results in pivotal movement of the horizontal portion, wherein the pivotal movement of the horizontal portion results in up and down vertical movement of the opposed blade assemblies, and wherein each opposed blade assembly moves in an opposite direction relative to the movement of the opposed blade assembly.

The round or an oval cylinder shaped shaving head 100 is designed to be used to shave around the genital and buttocks area and the shaped lends itself to efficiently shave within the creases and folds of skin in these areas and also may comprise a round dome 102 for additional comfort while shaving these sensitive areas. In some embodiments, the housing comprises a dome shaped end cap at a first end of the housing. The dimensions of the round or an oval cylinder shaped shaving head 100 comprises a length from the shaving motor engagement portion 114 to the round dome 102 of between about 1.0 inches to about 3 inches and a width or diameter of between about 0.5 inches and 1.5 inches.

As illustrated with FIGS. 1 and 5A, the housing 118 comprises the housing holder portion 506 which comprises two opposed longitudinal side walls 508 and two opposed traverse side walls 510. As illustrated, with FIG. 1, the housing 118 comprises two opposed housing holder portions. In some embodiments, the opposed housing holder portions each comprise two opposed longitudinal side walls and two opposed traverse side walls, and wherein the opposed housing holder portions are capable of holding each foil shaving portion and corresponding blade assemblies.

In some embodiments, the round or an oval cylinder shaped shaving head further comprises that each blade assembly is held aligned against the foil with a plurality of blade assembly guides 142 and/or a horizontal portion mounted for pivotal movement about a central axis and adjoining each blade assembly. In some embodiments, the blade assembly guides 142 each further comprise one or more springs that exert pressure holding each blade assembly against the foil.

In another aspect, disclosed herein is an electric shaving apparatus comprising a shaving head, the shaving head comprising: a) a triangular shaped housing having angularly opposed housing holder portions; b) two opposed foil shaving portions; c) a shaving motor engagement portion at a second end of the housing; d) at least two push rods; e) at least two blade assemblies, wherein each blade assembly is independently positioned for lateral movement against the foil portions; and f) a double-armed drive portion mounted for pivotal movement about a central axis, wherein each push rod is independently pivotally attached at a first end to opposed sides of the double-armed drive portion.

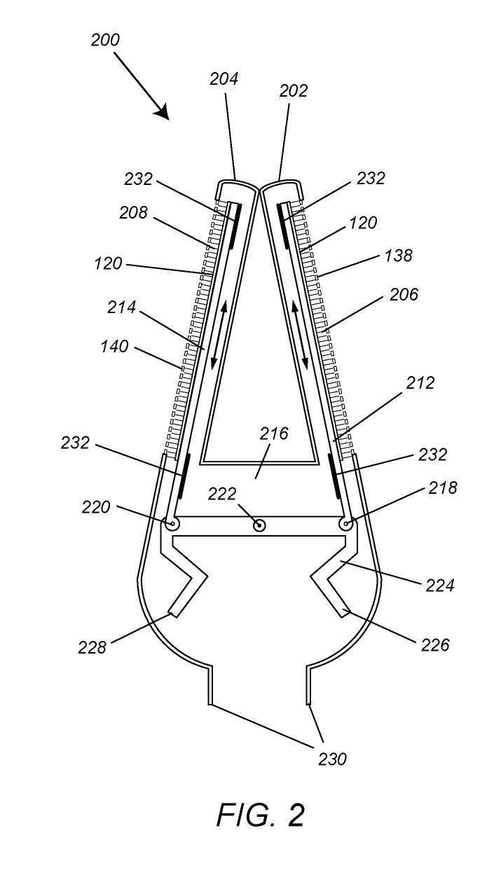

Referring to the drawings, FIGS. 2, 5A and 5B illustrate a triangular shaped shaving head 200 having two opposed foil shaving portions 138 and 140 and an electric shaving apparatus 600 comprising a shaving motor 602 having a rotatable cam 604. In some embodiments, each foil shaving portion is mounted on a different edge of the triangular shaped housing via the opposed housing holder portions, wherein the two opposed foil shaving portions are oriented at angles relative to each other, wherein the foil has a uniform thickness and a curvature, wherein the foil has a perforated region comprising a surface with a plurality of openings, and wherein each opening is separated from adjacent openings by a uniform distance. The reciprocating blades 206 and 208 are oscillated laterally back and forth against the underside concave portion of the opposed foil shaving portions 138 and 140, respectively. In some embodiments, the shaving head comprises two push rods. Push rods 212 and 214 are pivotally attached to a double-armed drive portion 224, wherein the double-armed drive portion movement is provided by rotation of the rotating cam 604. In some embodiments, the shaving head comprises two push rods. FIG. 2 depicts the blade holders 120 between the reciprocating blades 206 and 208 and attached to push rods 212 and 214. In some embodiments, the each blade assembly is attached to a blade holder. The rotating cam 604 rotates and engages with the left arm 228 and right arm 226 double-armed drive portion 224 which is attached to the housing via a free fix pin 222, thereby providing oscillating up and down movement of push rods 212 and 214, which are pivotally attached to the left arm 228 and right arm 226 via free pins 220 and 218. In some embodiments, the two push rods that are pivotally adjoined to each blade holder portion and mounted for up and down vertical movement of each blade assembly. In some embodiments, the two push rods that are pivotally adjoined to each blade holder portion and mounted for up and down vertical movement of each blade assembly, wherein each push rod is held aligned against the foil with a plurality of push rod guides 232. In some embodiments, the push rod guides 232 each further comprise one or more springs that exert pressure holding each blade assembly against the foil

The oscillating up and down movement of the left arm 228 and right arm 226 provides the oscillating up and down movement of push rods 212 and 214, which moves reciprocating blades 206 and 208 in an opposite direction relative to each other. The shaving motor engagement portion 230 is capable of attaching to the shaving motor housing 606 and allowing for engagement with the rotating cam 604. In some embodiments, the shaving head further comprises that the shaving motor engagement portion is capable of engagement a rotating cam, wherein the double-armed drive portion movement is provided by rotation of the cam. In some embodiments, the shaving head further comprises that the shaving motor engagement portion is capable of engagement a rotating cam, wherein the cam rotation results in pivotal movement of the double-armed drive portion, wherein the pivotal movement of the double-armed drive portion results in movement of each push rod, wherein the pivotal movement of each push rod results in vertical movement of the opposed blade assemblies, and wherein each opposed blade assembly moves in an opposite vertical direction relative to the other blade assembly.

The angled shaving head 200 is designed to be used to shave around the genital and buttocks area and the shape lends itself to efficiently shave within the creases and folds of skin in these areas and also may comprise round domes 202 and 204 for additional comfort while shaving these sensitive areas. In some embodiments, the housing comprises at least one dome shaped end cap at a first end of the housing. The dimensions of the angled shaving head 200 is about 1.5 inches to about 3 inches length from engagement portion 230 to the round domes 202 and 204 and the width of the opposed housing holder portions 506 is between about 0.5 inches to about 2.0 inches.

As illustrated with FIGS. 2 and 5A, the housing 216 comprises angularly opposed housing holder portions 506, which comprises two opposed longitudinal side walls 508 and two opposed traverse side walls 510. As illustrated, with FIG. 2, the housing 216 comprises two opposed housing holder portions. In some embodiments, the opposed housing holder portions each comprise two opposed longitudinal side walls and two opposed traverse side walls, and wherein the opposed housing holder portions are capable of holding each foil shaving portion and each corresponding blade assembly.

In another aspect, disclosed herein is an electric shaving apparatus comprising a hair trimming head, the hair trimming head comprising: a) a round or an oval cylinder shaped housing having a housing holder portion capable of holding a blade assembly, wherein the blade assembly is attached parallel to a latitude of the housing, wherein the blade assembly comprises: a stationary blade, and a reciprocating blade; b) a shaving motor engagement portion at a second end of the housing; c) at least one push rod; and d) a double-armed drive portion mounted for pivotal movement about a central axis, wherein the double-armed drive portion comprises a fixed free pin at a first side, and the at least one push rod is pivotally attached to an opposing side of the double-armed drive portion.

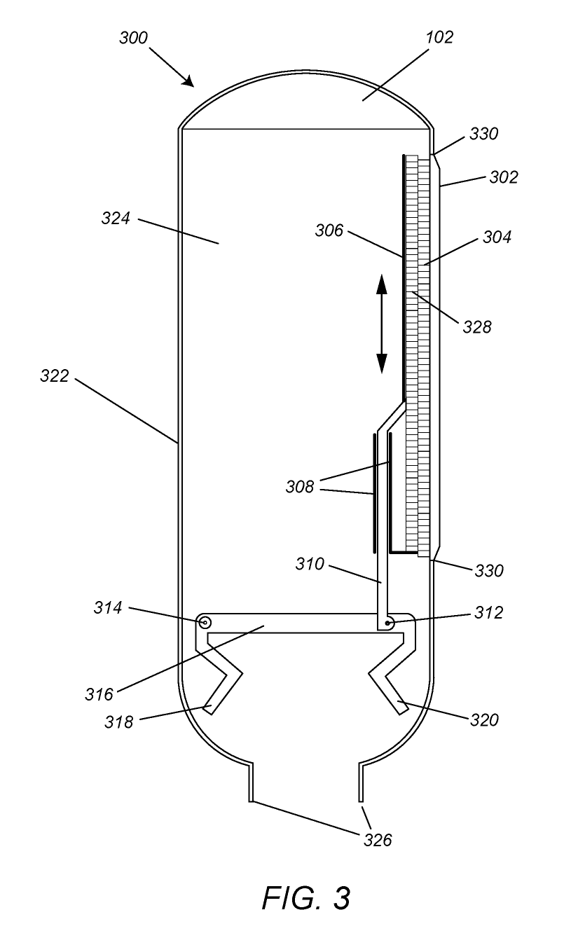

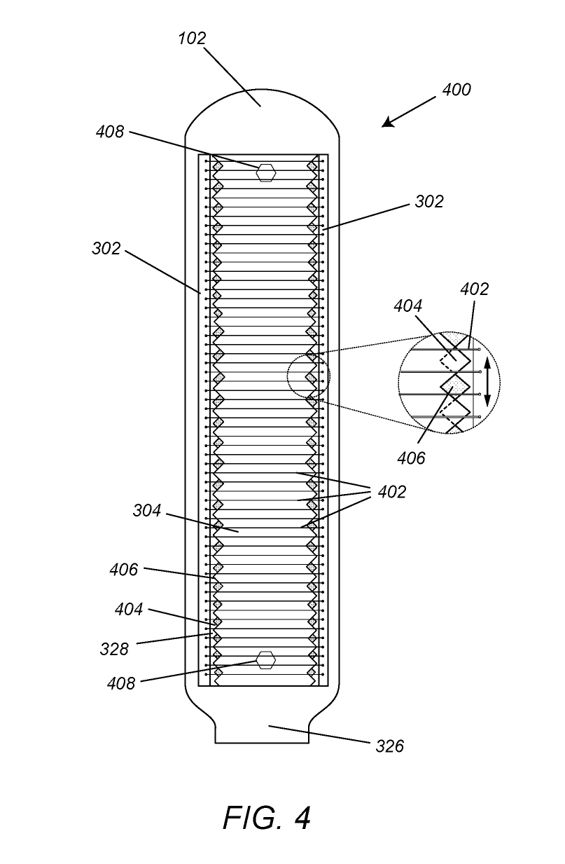

Referring to the drawings, FIGS. 3, 4 and 5B illustrate an electric shaving apparatus comprising a hair trimming head 300 having a stationary blade 304 and a reciprocating blade 328. As illustrated with FIG. 3, the side of the housing 324 opposite the stationary blade 304 and the reciprocating blade 328 comprises a full housing backing portion 322. In some embodiments, the hair trimming head further comprises that the stationary blade is held in the housing holder portion, wherein the stationary blade comprises a plurality of opposed stationary teeth arranged in a row along each opposed length of the stationary blade, wherein the stationary teeth 404 form an angled blade edge. In some embodiments, the reciprocating blade comprises a plurality of teeth 406 which complement the stationary blade teeth, and wherein the reciprocating teeth form a substantially angled line to and adjacent to the angled blade edge, wherein the reciprocating blade being slidable over a maximum distance 330.

The oscillating up and down movement of the left arm 319 and right arm 320 provides the oscillating up and down movement of push rod 310, which moves reciprocating blade 328. The shaving motor engagement portion 326 is capable of attaching to the shaving motor housing 606 and allowing for engagement with the rotating cam 604. In some embodiments, the hair trimming head further comprises at least two push rod guides that slidably press the reciprocating blade against the stationary blade for reciprocation of the reciprocating blade. In some embodiments, the hair trimming head further comprises that the reciprocating blade travels over an operating stroke distance, wherein the operating stroke distance being shorter than the maximum distance.

The rotating cam 604 rotates and engages with the left arm 318 and right arm 320 and the double-armed drive portion 316, which is attached to the housing via free fixed pin 314, thereby providing oscillating up and down movement of push rod 310, which is pivotally attached to the right arm 320 via free pin 312. In some embodiments, the oscillating up and down movement of push rod 310 moves reciprocating blade 328. In some embodiments, the push rod holds the reciprocating blade 328 against an underside of the stationary blade 304. In some embodiments, the hair trimming head further comprises that the reciprocating blade 328 is held aligned against the stationary blade 304 with a plurality of push rod guides 308. In some embodiments, the push rod guides 308 each further comprise one or more springs that exert pressure holding the reciprocating blade 328 against the stationary blade 304. In some embodiments, the stationary blade 304 is attached to the housing 324 via a plurality of stationary blade fasteners 408.

The hair trimming heads 300 and 400 are designed to be used to trim hair around the genital and buttocks area and the shape lends itself to efficiently shave within the creases and folds of skin in these areas and also may comprise round domes 102 for additional comfort while shaving these sensitive areas. The dimensions of the hair trimming head 300 comprises a length from the shaving motor engagement portion 326 to the round dome 102 of between about 1.0 inches to about 3 inches and a width or diameter of between about 0.5 inches and 1.5 inches. In some embodiments, the housing comprises at least one dome shaped end cap at a first end of the housing. In some embodiments, the housing comprises a dome shaped end cap at a first end of the housing. In some embodiments, the hair trimming head further comprises that the housing comprises skin protector portions 302 on opposed longitudinal sides of the blade assembly. In some embodiments, the hair trimming head further comprises that the housing comprises skin protective raised portions 302 on opposed longitudinal sides of the blade assembly, wherein the skin protective raised portions comprise a plurality of parallel skin protective wires 402 bridging the skin protective raised portions and running over the blade assembly. In some embodiments, the hair trimming head further comprises that the housing comprises skin protective raised portions 302 on opposed longitudinal sides of the blade assembly, wherein the skin protective raised portions 302 comprise a plurality of parallel skin protective wires 402 bridging the skin protective raised portions and running over the blade assembly, wherein the parallel skin protective wires 402 are spaced at intervals of between about 1 mm to about 4 mm. In some embodiments, the hair trimming head further comprises a housing casing portion 306 surrounding the perimeter of the sides of the housing adjacent to the blade assembly.

Referring to the drawings, FIG. 5A is an exploded view of an illustration of a round or an oval cylinder shaped shaving head 500 having a foil shaving portion 502, blade assembly 504 and a round or an oval cylinder shaped housing comprises the housing holder portion 506. The round or an oval cylinder shaped shaving head 500, wherein the blade assembly 504 comprises a plurality of individual blades 514. The foil shaving portion 502 has a width of between about 0.5 to about 1.5 inches.

Also shown in FIG. 5A, the round or an oval cylinder shaped shaving head 500 comprises a foil shaving portion 502, which is secured to a housing holder portion 506 that comprises two opposed longitudinal side walls 508 and two opposed traverse side walls 510. The foil shaving portion 502 has a curved shape which conforms to the contour of the blade assembly 504. The foil shaving portion 502 is designed such that it can be fixed to and readily removed from the shaving housing holder portion 506.

In the operating mode of round or an oval cylinder shaped shaving head 100, the blade assembly 504 in a linear oscillating motion relative to the foil shaving portion 502 by an electric motor 602 via the rotating cam 604 of FIGS. 5A and 5B. The movement of the blade assembly 504 relative to the foil shaving portion 502 results in hairs, which penetrate through one of the perforated foil shaving portion 502 as far as the associated blade assembly 504, being captured by the blade assembly 504 and severed in cooperation with the foil shaving portion 502.

FIG. 5A shows a foil shaving portion 502 in a partial representation. The foil shaving portion 502 includes a plurality of holes 512 which are separated from each other. The foil shaving portion 502 of arched shape may be regarded in simplified terms as a rigid cylinder which during the shaving operation is pressed in the region of a zenith of a curvature against the skin. The skin then represents an elastic medium. As a result, the skin yields elastically and nestles up against the curvature of the foil shaving portion 502. Also, the skin arches into the holes 512 of the foil shaving portion 502.

Referring to the drawings, FIG. 5B is a side view of an illustration of an electric shaving apparatus 600 comprising a shaving motor 602 having a rotatable cam 604 and an ON/OFF power button or switch.

The presently disclosed electric shaving apparatus and shaving heads is/are not to be limited in scope by the specific embodiments described herein, which are intended as single illustrations of individual aspects of the presently disclosed devices and methods, and functionally equivalent devices, methods and components are within the scope of the presently disclosed electric shaving apparatus and shaving heads. Indeed, various modifications of the presently disclosed electric shaving apparatus and shaving heads, in addition to those shown and described herein will become apparent to those skilled in the art from the foregoing description and accompanying drawings. Such modifications are intended to fall within the scope of the appended claims.

What is claimed is:

1. An electric shaving apparatus comprising a shaving head, the shaving head comprising:
a) a round or an oval cylinder shaped housing having opposed housing holder portions;
b) two opposed foil shaving portions;
c) a dome shaped end cap at a first end of the housing;
d) a shaving motor engagement portion at a second end of the housing;
e) at least two push rods;
f) at least two blade assemblies, wherein each blade assembly is independently positioned for lateral movement against the foil portions; and
g) a double-armed drive portion mounted for pivotal movement about a central axis, wherein each push rod is independently pivotally attached at a first end to opposed sides of the double-armed drive portion.

2. The shaving head of claim 1, wherein the opposed housing holder portions each comprise two opposed longitudinal side walls and two opposed traverse side walls, and wherein the opposed housing holder portions are capable of holding each foil shaving portion and corresponding blade assemblies;
wherein the housing comprises a dome shaped end cap at a first end of the housing;
wherein the foil has a uniform thickness and a curvature, wherein the foil has a perforated region comprising a surface with a plurality of openings, and wherein each opening is separated from adjacent openings by a uniform distance;
wherein the shaving head comprises two push rods; and
wherein each blade assembly is attached to a blade holder and adjoined via a horizontal portion.

3. The shaving head of claim 1, further comprising a horizontal portion mounted for pivotal movement about a central axis and adjoining each blade assembly.

4. The shaving head of claim 1, further comprising that each blade assembly is held aligned against the foil with a plurality of push rod guides and/or a horizontal portion mounted for pivotal movement about a central axis and adjoining each blade assembly.

5. The shaving head of claim 1, further comprising a horizontal portion, wherein two push rods are pivotally adjoined at a second end to a left side of the horizontal portion and a right side of the horizontal portion.

6. The shaving head of claim 1, further comprising a horizontal portion mounted for pivotal movement about a central axis, wherein a first terminal end of the horizontal portion is mounted to about the center of a first blade assembly and a second terminal end of the horizontal portion is mounted to about the center of a second blade assembly.

7. The shaving head of claim 1, further comprising that the shaving motor engagement portion is capable of engagement a rotating cam, wherein the double-armed drive portion movement is provided by rotation of the cam.

8. The shaving head of claim 1, further comprising that the shaving motor engagement portion is capable of engagement a rotating cam, wherein the cam rotation results in the pivotal movement of the double-armed drive portion, wherein the pivotal movement of the double-armed drive portion results in up and down movement of each push rod, wherein the up and down movement of each push rod results in pivotal movement of the horizontal portion, wherein the pivotal movement of the horizontal portion results in up and down vertical movement of the opposed blade assemblies, and wherein each opposed blade assembly moves in an opposite direction relative to the movement of the opposed blade assembly.

9. An electric shaving apparatus comprising a shaving head, the shaving head comprising:
a) a triangular shaped housing having angularly opposed housing holder portions;
b) two opposed foil shaving portions;
c) a shaving motor engagement portion at a second end of the housing;
d) at least two push rods;
e) at least two blade assemblies, wherein each blade assembly is independently positioned for lateral movement against the foil portions; and
f) a double-armed drive portion mounted for pivotal movement about a central axis, wherein each push rod is independently pivotally attached at a first end to opposed sides of the double-armed drive portion.

10. The shaving head of claim 9, wherein the opposed housing holder portions each comprise two opposed longitudinal side walls and two opposed traverse side walls, and wherein the opposed housing holder portions are capable of holding each foil shaving portion and each corresponding blade assembly;
wherein each foil shaving portion is mounted on a different edge of the triangular shaped housing via the opposed housing holder portions, wherein the two opposed foil shaving portions are oriented at angles relative to each other, wherein the foil has a uniform thickness and a curvature, wherein the foil has a perforated region comprising a surface with a plurality of openings, and wherein each opening is separated from adjacent openings by a uniform distance;
wherein the housing comprises at least one dome shaped end cap at a first end of the housing;
wherein the shaving head comprises two push rods; and
wherein each blade assembly is attached to a blade holder.

10. The shaving head of claim 9, comprising two push rods that are pivotally adjoined to each blade holder portion and mounted for up and down vertical movement of each blade assembly.

11. The shaving head of claim 9, comprising two push rods that are pivotally adjoined to each blade holder portion and mounted for up and down vertical movement of each blade assembly, wherein each push rod is held aligned against the foil with a plurality of push rod guides.

12. The shaving head of claim 9, further comprising that the shaving motor engagement portion is capable of engagement a rotating cam, wherein the double-armed drive portion movement is provided by rotation of the cam.

13. The shaving head of claim 9, further comprising that the shaving motor engagement portion is capable of engagement a rotating cam, wherein the cam rotation results in pivotal movement of the double-armed drive portion, wherein the pivotal movement of the double-armed drive portion results in movement of each push rod, wherein the pivotal movement of each push rod results in vertical movement of the opposed blade assemblies, and wherein each opposed blade assembly moves in an opposed vertical direction relative to the other blade assembly.

14. An electric shaving apparatus comprising a shaving head, the shaving head comprising:
a) a round or an oval cylinder shaped housing having a housing holder portion capable of holding a blade assembly, wherein the blade assembly is attached parallel to a latitude of the housing, wherein the blade assembly comprises: a stationary blade, and a reciprocating blade;
b) a shaving motor engagement portion at a second end of the housing;
c) at least one push rod; and
d) a double-armed drive portion mounted for pivotal movement about a central axis, wherein the double-armed drive portion comprises a fixed free pin at a first side, and the at least one push rod is pivotally attached to an opposing side of the double-armed drive portion.

15. The hair trimming head of claim 14, further comprising that the stationary blade is held in the housing holder portion, wherein the stationary blade comprises a plurality of opposed stationary teeth arranged in a row along each opposed length of the stationary blade, wherein the stationary teeth form an angled blade edge;
wherein the reciprocating blade comprises a plurality of teeth which complement the stationary blade teeth, and wherein the reciprocating teeth form a substantially angled line to and adjacent to the angled blade edge, wherein the reciprocating blade being slidable over a maximum distance; and
wherein the housing comprises a dome shaped end cap at a first end of the housing.

16. The hair trimming head of claim 14, further comprising at least two push rod guides that slidably press the reciprocating blade against the stationary blade for reciprocation of the reciprocating blade.

17. The hair trimming head of claim 14, further comprising that the reciprocating blade travels over an operating stroke distance, wherein the operating stroke distance being shorter than the maximum distance.

18. The hair trimming head of claim 14, further comprising that the housing comprises skin protector portions on opposed longitudinal sides of the blade assembly.

19. The hair trimming head of claim 14, further comprising that the housing comprises skin protective raised portions on opposed longitudinal sides of the blade assembly, wherein the skin protective raised portions comprise a plurality of parallel skin protective wires bridging the skin protective raised portions and running over the blade assembly.

20. The hair trimming head of claim 14, further comprising that the housing comprises skin protective raised portions on opposed longitudinal sides of the blade assembly, wherein the skin protective raised portions comprise a plurality of parallel skin protective wires bridging the skin protective raised portions and running over the blade assembly, wherein the parallel skin protective wires are spaced at intervals of between about 1 mm to about 4 mm.
